(19) United States
(12) Patent Application Publication
(10) Pub. No.: US 2017/0146857 A1
(43) Pub. Date: May 25, 2017

(54) COLOR LIGHT-EMITTING ELEMENT AND LIQUID CRYSTAL DISPLAY

(71) Applicant: Shenzhen China Star Optoelectronics Technology Co. Ltd., Shenzhen City (CN)

(72) Inventors: Yanan Wang, Shenzhen City (CN); Yungjui Lee, Shenzhen City (CN)

(21) Appl. No.: 14/781,310

(22) PCT Filed: Aug. 24, 2015
(86) PCT No.: PCT/CN2015/087908

§ 371 Date: Sep. 30, 2015

(30) Foreign Application Priority Data
Aug. 4, 2015 (CN) 201510472862.9

(51) Int. Cl. G02F 1/1335; G02F 1/1339; G02F 1/1337; G02F 1/1343; G02F 1/1368

(52) U.S. Cl. CPC G02F 1/133617; G02F 1/134309; G02F 1/1368; G02F 1/133528; G02F 1/1337; G02F 1/13394; G02F 1/133621; G02F 2001/133614; G02F 2201/123; G02F 2001/134345; G02F 2201/121; G02F 2202/36; G02F 2201/50

(57) ABSTRACT

The present invention provides a color light-emitting element and a liquid crystal display. The color light-emitting element includes a photo-luminescent film formed of quantum dot materials and a reflection enhancement film and a transmission enhancement film respectively formed on two sides of the photo-luminescent film. When irradiated by backlighting, the photo-luminescent film emits red, green, and blue light and the reflection enhancement film and the transmission enhancement film condense the light emitting from the photo-luminescent film and concentrate and transmit out the light through the transmission enhancement film, whereby light can be utilized in a more efficient manner and utilization of backlighting is increased. The liquid crystal display includes the color light-emitting element to substitute color resist layers used in a liquid crystal display panel and makes use of the excellent light emission characteristics of quantum dots to achieve high color gamut displaying and high color purity and thus enhance the displaying performance of a liquid crystal display panel.

### BACKGROUND OF THE INVENTION

1. Field of the Invention

The present invention relates to the field of display technology, and in particular to a color light-emitting element and a liquid crystal display comprising the color light-emitting element.

2. The Related Arts

A liquid crystal display (LCD) has a variety of advantages, including thin device body, low power consumption, and being free of radiation, and is thus widely used. Most of the LCDs that are available in the market are backlighting LCDs, which comprise a liquid crystal display panel and a backlight module. The liquid crystal display panel is commonly made up of a color filter (CF) substrate, a thin-film transistor (TFT) substrate, liquid crystal (LC) interposed between the CF substrate and the TFT substrate, and a sealant from. The operation principle of the liquid crystal display panel is that the liquid crystal molecules are arranged between the two parallel glass substrates and the orientation of the liquid crystal molecules is determined by whether electricity is applied to the glass substrates or not, in order to change the polarization state of light from the backlight module. Polarizers are provided to achieve blocking or passing of light thereby realizing the purpose of displaying.

Based on the operation modes of liquid crystal, the LCDs are classified as phase change (PC) type, twisted nematic (TN) type, super twisted nematic (STN) type, vertical alignment (VA) type, and in-plane switching (IPS) type. These types each have their own advantages and are applicable in different fields. The TN type has high contrast, but shows more severe color shift accompanying therewith. The IPS type has excellent performance in respect of color shifting, but has a low contrast. The VA type has high contrast and excellent performance in respect of color shifting, but is not suitable for touch panels. These display types that are currently known each have their advantages in different fields, but the development direction of the mainstream LCDs, such as high color gamut and 3D fast response, raises severer challenges to all these types of liquid crystal display types.

The conventional LCD often comprises RGB color resist layers arranged on the CF substrate to filter and absorb light transmitting through the liquid crystal layer so that the light of each pixel, after being transmitted out, is generally composed of three primary colors of R, G, and B and different pixels emit different colors of light, whereby full color displaying can be achieved through spatial color mixture. However, the CF substrate allows only light of a fraction of the waveband to pass so that when light is filtered with the RBG color resist layers, the utilization of light drops down to ⅓. Most of the light is absorbed by the RBG color resist materials and light intensity utilization is lowered. In other words, the utilization of the energy of the backlighting is low. Currently, a filter film that comprises a light conversion layer based on quantum dots is available. The quantum dot may emit high purity light, which can be used to better and expand the color gamut of an LCD device. Light is converted from a short wavelength band to a long wavelength band, wherein the loss of conversion is low. The utilization of backlighting can be significantly improved. However, for quantum dots, the photo-luminescent light generated thereby is of no directionality. Thus, a filter film composed of a quantum dot based light conversion layer still needs for further improvement in respect of utilization of backlighting.

### SUMMARY OF THE INVENTION

An object of the present invention is to provide a color light-emitting element, which comprises a photo-luminescent film formed of quantum dot materials and a reflection enhancement film and a transmission enhancement film respectively formed on two sides of the photo-luminescent film so that when irradiated by backlighting, the photo-luminescent film emits red, green, and blue light and the reflection enhancement film and the transmission enhancement film condense the light emitting from the photo-luminescent film and concentrate and transmit out the light through the transmission enhancement film to thereby utilize the light in a more efficient manner and increase the utilization of backlighting.

Another object of the present invention is to provide a liquid crystal display, which comprises the above-described color light-emitting element to substitute color resist layers used in a liquid crystal display panel and makes use of the excellent light emission characteristics of quantum dots to achieve high color gamut displaying and high color purity and thus enhance the displaying performance of a liquid crystal display panel.

To achieve the above objects, the present invention provides a color light-emitting element, which comprises a photo-luminescent film and a reflection enhancement film and a transmission enhancement film respectively formed on two sides of the photo-luminescent film;

the photo-luminescent film comprising a red sub-pixel pattern, a green sub-pixel pattern, and a blue sub-pixel pattern;

the red sub-pixel pattern being formed of a red quantum dot material, the green sub-pixel pattern being formed of a green quantum dot material, the blue sub-pixel pattern being formed of a blue quantum dot material or a non-luminous transparent organic material;

wherein when blue-violet light or blue light irradiates the color light-emitting element from a side thereof associated with the reflection enhancement film, the red sub-pixel pattern, the green sub-pixel pattern, and the blue sub-pixel pattern of the photo-luminescent film respectively emit red, green, and blue light and the light emitting from the photo-luminescent film is condensed through the reflection enhancement film and the transmission enhancement film and then transmitted out from a side associated with the transmission enhancement film.

For the blue sub-pixel pattern being formed of the blue quantum dot material, when blue-violet light is used to irradiate the color light-emitting element, the red sub-pixel pattern, the green sub-pixel pattern, and the blue sub-pixel pattern of the photo-luminescent film are excited by the blue-violet light to respectively emit red, green, and blue light.

For the blue sub-pixel pattern being formed of the non-luminous transparent organic material, when blue light is used to irradiate the color light-emitting element, the red sub-pixel pattern and the green sub-pixel pattern of the photo-luminescent film are excited by the blue-violet light to respectively emit red and green light and the blue light transmits through the transparent blue sub-pixel pattern to make the blue sub-pixel pattern emitting blue light.

The transmission enhancement film has a thickness of 110 nm-160 nm, 1430 nm-1490 nm, or 1720 nm-1760 nm; and the reflection enhancement film has a thickness of 320 nm-350 nm, 1900 nm-2200 nm, or 2150 -2300 nm.

The present invention also provides a liquid crystal display, which comprises a liquid crystal display panel and a backlight module arranged at one side of the liquid crystal display panel;

the liquid crystal display panel comprising an upper substrate, a lower substrate opposite to the upper substrate, a liquid crystal layer arranged between the upper substrate and the lower substrate, and photo spacers formed between the upper and lower substrates;

the upper substrate comprising a first base plate, a common electrode and a first alignment film formed on a lower surface of the first base plate, an upper polarizer formed on an upper surface of the first base plate, a color light-emitting element formed on the upper polarizer, and a protection film formed on the color light-emitting element;

the color light-emitting element comprising a photo-luminescent film and a reflection enhancement film and a transmission enhancement film respectively formed on two opposite sides of the photo-luminescent film;

the photo-luminescent film comprising a red sub-pixel pattern, a green sub-pixel pattern, and a blue sub-pixel pattern;

the red sub-pixel pattern being formed of a red quantum dot material, the green sub-pixel pattern being formed of a green quantum dot material, the blue sub-pixel pattern being formed of a blue quantum dot material or a non-luminous transparent organic material;

wherein when blue-violet light or blue light irradiates the color light-emitting element from a side thereof associated with the reflection enhancement film, the red sub-pixel pattern, the green sub-pixel pattern, and the blue sub-pixel pattern of the photo-luminescent film respectively emit red, green, and blue light and the light emitting from the photo-luminescent film is condensed through the reflection enhancement film and the transmission enhancement film and then transmitted out from a side associated with the transmission enhancement film.

For the blue sub-pixel pattern being formed of the blue quantum dot material, the backlight module supplies blue-violet light; and for the blue sub-pixel pattern being formed of the non-luminous transparent organic material, the backlight module supplies blue light.

The present invention further provides a liquid crystal display, which comprises a liquid crystal display panel and a backlight module arranged at one side of the liquid crystal display panel;

the liquid crystal display panel comprising an upper substrate, a lower substrate opposite to the upper substrate, a liquid crystal layer arranged between the upper substrate and the lower substrate, and photo spacers formed between the upper and lower substrates;

the upper substrate comprising a first base plate, a color light-emitting element formed under the first base plate, an upper polarizer formed under the color light-emitting element, and a common electrode and a first alignment film formed under the upper polarizer; the color light-emitting element comprising a photo-luminescent film and a reflection enhancement film and a transmission enhancement film respectively formed on two opposite sides of the photo-luminescent film;

the photo-luminescent film comprising a red sub-pixel pattern, a green sub-pixel pattern, and a blue sub-pixel pattern;

the red sub-pixel pattern being formed of a red quantum dot material, the green sub-pixel pattern being formed of a green quantum dot material, the blue sub-pixel pattern being formed of a blue quantum dot material or a non-luminous transparent organic material;

wherein when blue-violet light or blue light irradiates the color light-emitting element from a side thereof associated with the reflection enhancement film, the red sub-pixel pattern, the green sub-pixel pattern, and the blue sub-pixel pattern of the photo-luminescent film respectively emit red, green, and blue light and the light emitting from the photo-luminescent film is condensed through the reflection enhancement film and the transmission enhancement film and then transmitted out from the side of the transmission enhancement film.

For the blue sub-pixel pattern being formed of the blue quantum dot material, the backlight module supplies blue-violet light; and for the blue sub-pixel pattern being formed of the non-luminous transparent organic material, the backlight module supplies blue light.

The lower substrate comprises a second base plate, a lower polarizer formed on a lower surface of second base plate, a TFT layer formed on the second base plate, and a pixel electrode formed on the TFT layer, and a second alignment film formed on the pixel electrode.

The reflection enhancement film has a thickness of 320 nm-350 nm, 1900 nm-2200 nm, or 2150-2300 nm; and the transmission enhancement film has a thickness of 110 nm-160 nm, 1430 nm-1490 nm, or 1720 nm-1760 nm.

The efficacy of the present invention is that the present invention provides a color light-emitting element and a liquid crystal display. The color light-emitting element comprises a photo-luminescent film formed of quantum dot materials and a reflection enhancement film and a transmission enhancement film respectively formed on two sides of the photo-luminescent film. When irradiated by backlighting, the photo-luminescent film emits red, green, and blue light and the reflection enhancement film and the transmission enhancement film condense the light emitting from the photo-luminescent film and concentrate and transmit out the light through the transmission enhancement film, whereby light can be utilized in a more efficient manner and utilization of backlighting is increased. The liquid crystal display comprises the color light-emitting element to substitute color resist layers used in a liquid crystal display panel and makes use of the excellent light emission characteristics of quantum dots to achieve high color gamut displaying and high color purity and thus enhance the displaying performance and utilization of backlighting of the liquid crystal display panel. Further, the color light-emitting element comprises the transmission enhancement film and the reflection enhancement film arranged on upper and lower sides of the photo-luminescent film to effectively condense light emitting from the photo-luminescent film and have the light concentrated and transmitted out through the transmission enhancement film and also enhance the transmittance of the backlighting entering the photo-luminescent film to further increase the utilization of the backlighting.

### BRIEF DESCRIPTION OF THE DRAWINGS

The features and technical contents of the present invention will be apparent from the following detailed description of the present invention and the attached drawing; however, these drawings are provided for reference and illustration and are not intended to limit the scope of the present invention. In the drawing:

FIG. 1 is a schematic view illustrating a cross-section of a first embodiment of a light color-emitting element according to the present invention;

FIG. 2 is a schematic view illustrating a cross-section of a second embodiment of a light color-emitting element according to the present invention;

FIG. 3 is a schematic view illustrating a cross-section of a first embodiment of a liquid crystal display according to the present invention;

FIG. 4 is a schematic view illustrating a cross-section of a second embodiment of a liquid crystal display according to the present invention;

FIG. 5 is a schematic view illustrating a cross-section of a third embodiment of a liquid crystal display according to the present invention; and

FIG. 6 is a schematic view illustrating a cross-section of a fourth embodiment of a liquid crystal display according to the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

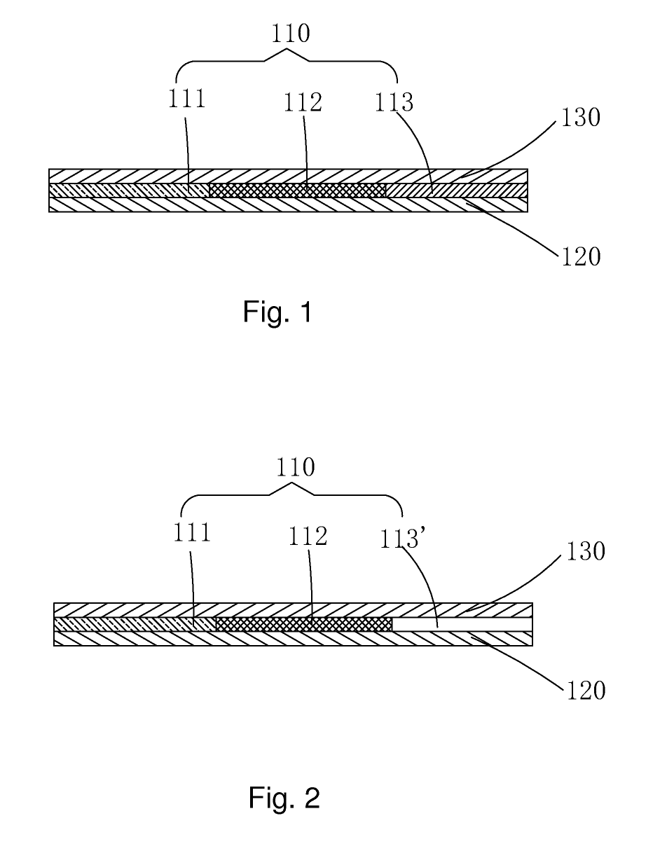

Referring to FIGS. 1-2, firstly, the present invention provides a color light-emitting element, which comprises a photo-luminescent film 110 and a reflection enhancement film 120 and a transmission enhancement film 130 respectively formed on two opposite sides of the photo-luminescent film 110.

The photo-luminescent film 110 comprise a red sub-pixel pattern 111, a green sub-pixel pattern 112, and a blue sub-pixel pattern 113/113′ formed thereon.

The red sub-pixel pattern 111 is formed of a red quantum dot material. The green sub-pixel pattern 112 is formed of a green quantum dot material. The blue sub-pixel pattern 113/113′ is formed of a blue quantum dot material or a non-luminous transparent organic material.

When blue-violet light or blue light irradiates the color light-emitting element from a side thereof associated with the reflection enhancement film 120, the red sub-pixel pattern 111, the green sub-pixel pattern 112, and the blue sub-pixel pattern 113/113′ of the photo-luminescent film 110 respectively emit red, green, and blue light. The light emitting from the photo-luminescent film 110 is condensed through the reflection enhancement film 120 and the transmission enhancement film 130 and then transmitted out from a side associated with the transmission enhancement film 130.

Specifically, as shown in FIG. 1, in case that the blue sub-pixel pattern 113 is formed of the blue quantum dot material, when blue-violet light irradiates the color light-emitting element, the red sub-pixel pattern 111, the green sub-pixel pattern 112, and the blue sub-pixel pattern 113 of the photo-luminescent film 110 are excited by the blue-violet light to respectively emit red, green, and blue light.

Specifically, as shown in FIG. 2, in case that the blue sub-pixel pattern 113′ is formed of the non-luminous transparent organic material, when blue light irradiates the color light-emitting element, the red sub-pixel pattern 111 and the green sub-pixel pattern 112 of the photo-luminescent film 110 are excited by the blue-violet light to respectively emit red and green light. The blue light transmits through the transparent blue sub-pixel pattern 113′ to make the blue sub-pixel pattern 113′ emitting blue light.

Specifically, the reflection enhancement film 120 has a thickness of 320 nm-350 nm, 1900 nm-2200 nm, or 2150-2300 nm; and the transmission enhancement film 130 has a thickness of 110 nm-160 nm, 1430 nm-1490 nm, or 1720 nm-1760 nm.

Theoretically, according to the theory of transmission enhancement, the film thickness must satisfy (2n+1)(λ/4), where A is wavelength of light, and the refractive index of the film=(n1*n2)̂(½), where n1 and n2 are respectively the refractive indexes of media on opposite sides of the film, to allow the transmission enhancement film to achieve an effect of complete transmission enhancement. According to the theory of reflection enhancement, when (2n+1)(λ/4), where A is wavelength of light, the transmission enhancement film achieve an effect of complete reflection enhancement. The achievement of the functions of the transmission enhancement film and the reflection enhancement film is closely related to the film thickness. In view of the relevance between the thickness of the film and the wavelength of light, in the present invention, the film thicknesses of the transmission enhancement film and the reflection enhancement film are determined according to the above formulas by taking the wavelengths of red, green, and blue colors into account.

The present invention provides a color light-emitting element, which comprises a reflection enhancement film 120 and a transmission enhancement film 130 respectively arranged on upper and lower sides of the photo-luminescent film 110 to effectively condense light emitting from a photo-luminescent film 110 and have the light concentrated and transmitted out through the transmission enhancement film 130, whereby light can be utilized in a more efficient manner and utilization of backlighting is increased.

Specifically, the red quantum dot material, the green quantum dot material, and the blue quantum dot material are semiconductor nano-crystalline materials or other photo-luminescent material having a narrow luminescence peak.

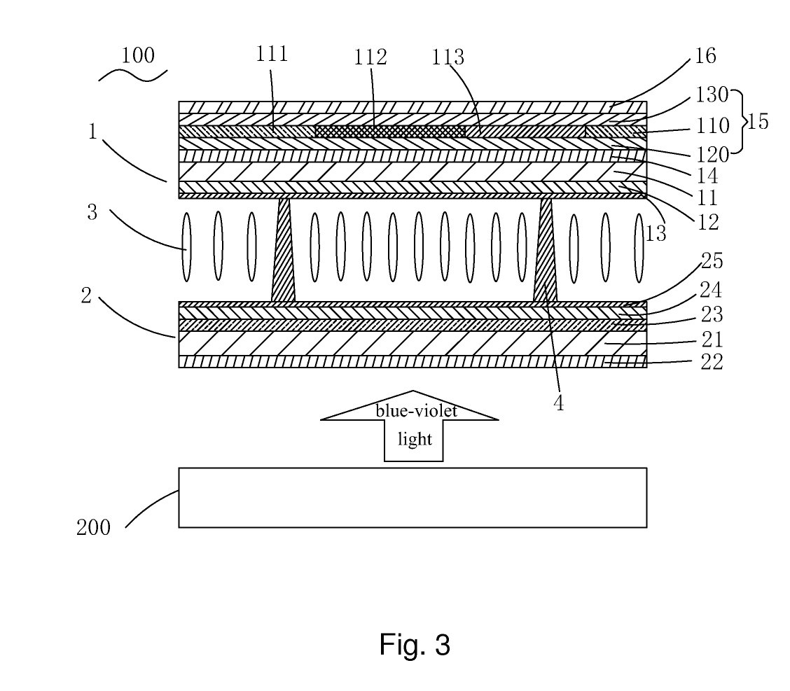

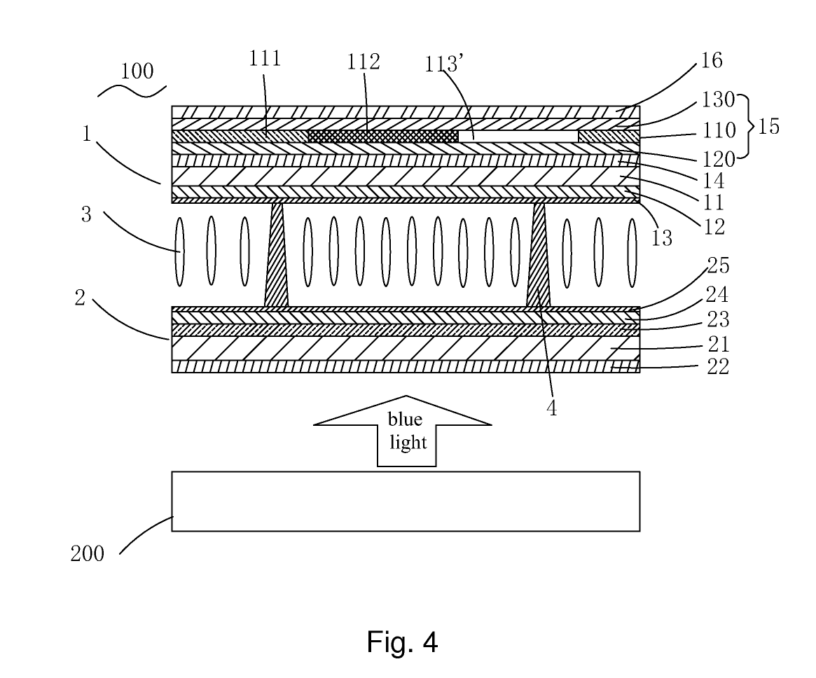

Referring to FIGS. 3-4, the present invention also provides a liquid crystal display, which comprises a liquid crystal display panel 100 and a backlight module 200 arranged at one side of the liquid crystal display panel 100.

The liquid crystal display panel 100 comprises an upper substrate 1, a lower substrate 2 opposite to the upper substrate 1, a liquid crystal layer 3 arranged between the upper substrate 1 and the lower substrate 2, and photo spacers 4 formed between the upper and lower substrates 1, 2.

The upper substrate 1 comprises a first base plate 11, a common electrode 12 and a first alignment film 13 formed on a lower surface of the first base plate 11, an upper polarizer 14 formed on an upper surface of the first base plate 11, a color light-emitting element 15 formed on the upper polarizer 14, and a protection film 16 formed on the color light-emitting element 15.

The lower substrate 2 comprises a second base plate 21, a lower polarizer 22 formed on a lower surface of second base plate 21, a thin-film transistor (TFT) layer 23 formed on the second base plate 21, and a pixel electrode 24 formed on the TFT layer 23, and a second alignment film 25 formed on the pixel electrode 24.

The color light-emitting element 15 comprises a photo-luminescent film 110 and a reflection enhancement film 120 and a transmission enhancement film 130 respectively formed on two opposite sides of the photo-luminescent film 110.

The photo-luminescent film 110 comprise a red sub-pixel pattern 111, a green sub-pixel pattern 112, and a blue sub-pixel pattern 113/113′ formed thereon.

The red sub-pixel pattern 111 is formed of a red quantum dot material. The green sub-pixel pattern 112 is formed of a green quantum dot material. The blue sub-pixel pattern 113/113′ is formed of a blue quantum dot material or a non-luminous transparent organic material.

When blue-violet light or blue light irradiates the color light-emitting element from a side thereof associated with the reflection enhancement film 120, the red sub-pixel pattern 111, the green sub-pixel pattern 112, and the blue sub-pixel pattern 113/113′ of the photo-luminescent film 110 respectively emit red, green, and blue light. The light emitting from the photo-luminescent film 110 is condensed through the reflection enhancement film 120 and the transmission enhancement film 130 and then transmitted out from a side associated with the transmission enhancement film 130.

Specifically, as shown in FIG. 3, in case that the blue sub-pixel pattern 113 is formed of the blue quantum dot material, the backlight module 200 supplies blue-violet light; as shown in FIG. 4, in case that the blue sub-pixel pattern 113′ is formed of the non-luminous transparent organic material, the backlight module 200 supplies blue light.

Specifically, the reflection enhancement film 120 has a thickness of 320 nm-350 nm, 1900 nm-2200 nm, or 2150-2300 nm; and the transmission enhancement film 130 has a thickness of 110 nm-160 nm, 1430 nm-1490 nm, or 1720 nm-1760 nm.

Preferably, the first base plate 11 and the second base plate 21 are both glass plates.

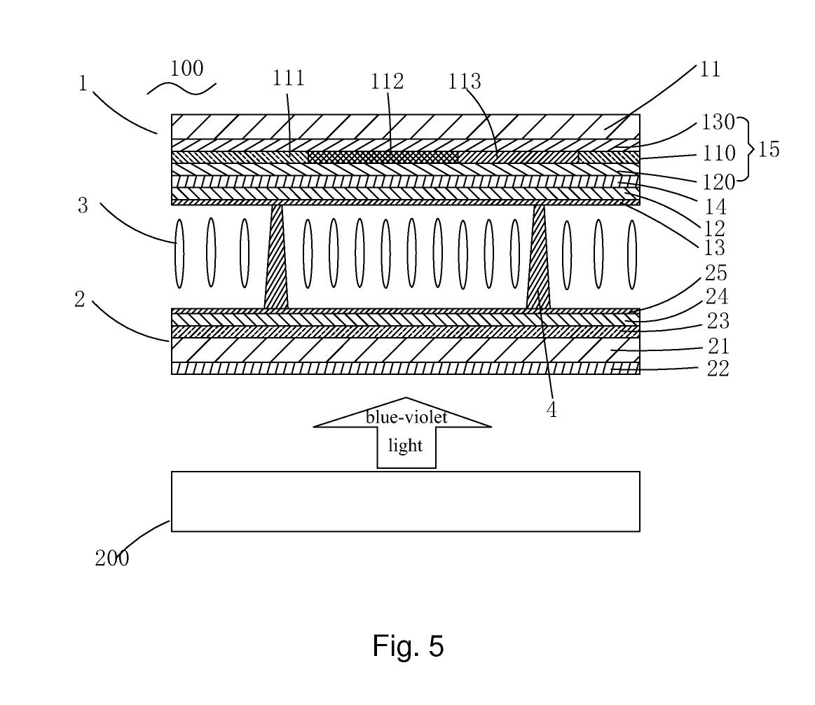

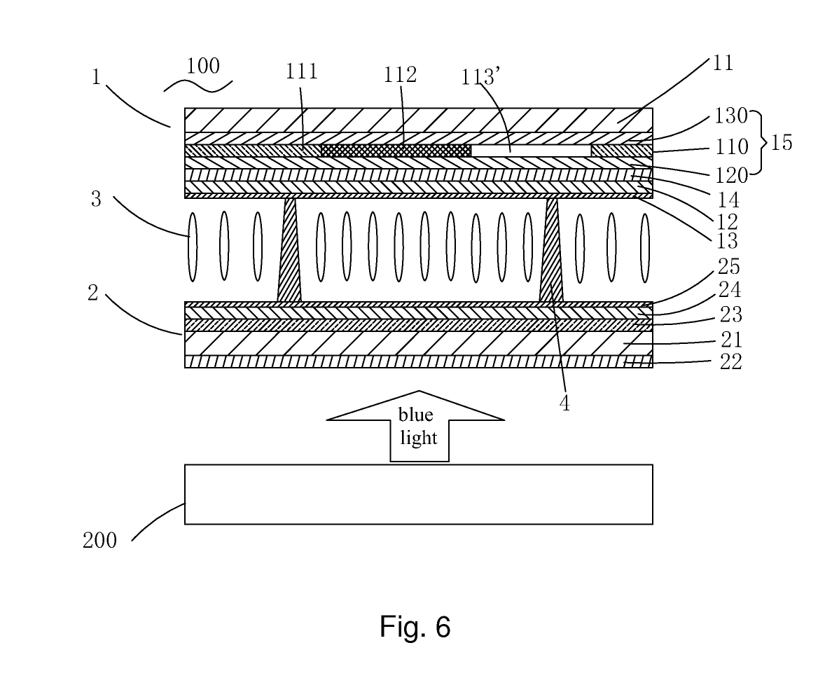

Referring to FIGS. 5-6, the present invention also provides another liquid crystal display, which comprises a liquid crystal display panel 100 and a backlight module 200 arranged at one side of the liquid crystal display panel 100.

The liquid crystal display panel 100 comprises an upper substrate 1, a lower substrate 2 opposite to the upper substrate 1, a liquid crystal layer 3 arranged between the upper substrate 1 and the lower substrate 2, and photo spacers 4 formed between the upper and lower substrates 1, 2.

The upper substrate 1 comprises a first base plate 11, a color light-emitting element 15 formed under the first base plate 11, an upper polarizer 14 formed under the color light-emitting element 15, and a common electrode 12 and a first alignment film 13 formed under the upper polarizer 14.

The lower substrate 2 comprises a second base plate 21, a lower polarizer 22 formed on a lower surface of second base plate 21, a TFT layer 23 formed on the second base plate 21, and a pixel electrode 24 formed on the TFT layer 23, and a second alignment film 25 formed on the pixel electrode 24.

The color light-emitting element 15 comprises a photo-luminescent film 110 and a reflection enhancement film 120 and a transmission enhancement film 130 respectively formed on two opposite sides of the photo-luminescent film 110.

The photo-luminescent film 110 comprise a red sub-pixel pattern 111, a green sub-pixel pattern 112, and a blue sub-pixel pattern 113/113′ formed thereon.

The red sub-pixel pattern 111 is formed of a red quantum dot material. The green sub-pixel pattern 112 is formed of a green quantum dot material. The blue sub-pixel pattern 113/113′ is formed of a blue quantum dot material or a non-luminous transparent organic material.

When blue-violet light or blue light irradiates the color light-emitting element from a side thereof associated with the reflection enhancement film 120, the red sub-pixel pattern 111, the green sub-pixel pattern 112, and the blue sub-pixel pattern 113/113′ of the photo-luminescent film 110 respectively emit red, green, and blue light. The light emitting from the photo-luminescent film 110 is condensed through the reflection enhancement film 120 and the transmission enhancement film 130 and then transmitted out from the side of the transmission enhancement film 130.

Specifically, as shown in FIG. 5, in case that the blue sub-pixel pattern 113 is formed of the blue quantum dot material, the backlight module 200 supplies blue-violet light; as shown in FIG. 6, in case that the blue sub-pixel pattern 113′ is formed of the non-luminous transparent organic material, the backlight module 200 supplies blue light.

Specifically, the reflection enhancement film 120 has a thickness of 320 nm-350 nm, 1900 nm-2200 nm, or 2150-2300 nm; and the transmission enhancement film 130 has a thickness of 110 nm-160 nm, 1430 nm-1490 nm, or 1720 nm-1760 nm.

Preferably, the first base plate 11 and the second base plate 21 are both glass plates.

In summary, the present invention provides a color light-emitting element and a liquid crystal display. The color light-emitting element comprises a photo-luminescent film formed of quantum dot materials and a reflection enhancement film and a transmission enhancement film respectively formed on two sides of the photo-luminescent film. When irradiated by backlighting, the photo-luminescent film emits red, green, and blue light and the reflection enhancement film and the transmission enhancement film condense the light emitting from the photo-luminescent film and concentrate and transmit out the light through the transmission enhancement film, whereby light can be utilized in a more efficient manner and utilization of backlighting is increased. The liquid crystal display comprises the color light-emitting element to substitute color resist layers used in a liquid crystal display panel and makes use of the excellent light emission characteristics of quantum dots to achieve high color gamut displaying and high color purity and thus enhance the displaying performance and utilization of backlighting of the liquid crystal display panel. Further, the color light-emitting element comprises the transmission enhancement film and the reflection enhancement film arranged on upper and lower sides of the photo-luminescent film to effectively condense light emitting from the photo-luminescent film and have the light concentrated and transmitted out through the transmission enhancement film and also enhance the transmittance of the backlighting entering the photo-luminescent film to further increase the utilization of the backlighting.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A color light-emitting element, comprising a photo-luminescent film and a reflection enhancement film and a transmission enhancement film respectively formed on two sides of the photo-luminescent film;
the photo-luminescent film comprising a red sub-pixel pattern, a green sub-pixel pattern, and a blue sub-pixel pattern;
the red sub-pixel pattern being formed of a red quantum dot material, the green sub-pixel pattern being formed of a green quantum dot material, the blue sub-pixel pattern being formed of a blue quantum dot material or a non-luminous transparent organic material;
wherein when blue-violet light or blue light irradiates the color light-emitting element from a side thereof associated with the reflection enhancement film, the red sub-pixel pattern, the green sub-pixel pattern, and the blue sub-pixel pattern of the photo-luminescent film respectively emit red, green, and blue light and the light emitting from the photo-luminescent film is condensed through the reflection enhancement film and the transmission enhancement film and then transmitted out from a side associated with the transmission enhancement film.

2. The color light-emitting element as claimed in claim 1, wherein for the blue sub-pixel pattern being formed of the blue quantum dot material, when blue-violet light is used to irradiate the color light-emitting element, the red sub-pixel pattern, the green sub-pixel pattern, and the blue sub-pixel pattern of the photo-luminescent film are excited by the blue-violet light to respectively emit red, green, and blue light.

3. The color light-emitting element as claimed in claim 1, wherein for the blue sub-pixel pattern being formed of the non-luminous transparent organic material, when blue light is used to irradiate the color light-emitting element, the red sub-pixel pattern and the green sub-pixel pattern of the photo-luminescent film are excited by the blue-violet light to respectively emit red and green light and the blue light transmits through the transparent blue sub-pixel pattern to make the blue sub-pixel pattern emitting blue light.

4. The color light-emitting element as claimed in claim 1, wherein the transmission enhancement film has a thickness of 110 nm-160 nm, 1430 nm-1490 nm, or 1720 nm-1760 nm; and the reflection enhancement film has a thickness of 320 nm-350 nm, 1900 nm-2200 nm, or 2150-2300 nm.

5. A liquid crystal display, comprising a liquid crystal display panel and a backlight module arranged at one side of the liquid crystal display panel;
the liquid crystal display panel comprising an upper substrate, a lower substrate opposite to the upper substrate, a liquid crystal layer arranged between the upper substrate and the lower substrate, and photo spacers formed between the upper and lower substrates;
the upper substrate comprising a first base plate, a common electrode and a first alignment film formed on a lower surface of the first base plate, an upper polarizer formed on an upper surface of the first base plate, a color light-emitting element formed on the upper polarizer, and a protection film formed on the color light-emitting element;
the color light-emitting element comprising a photo-luminescent film and a reflection enhancement film and a transmission enhancement film respectively formed on two opposite sides of the photo-luminescent film;
the photo-luminescent film comprising a red sub-pixel pattern, a green sub-pixel pattern, and a blue sub-pixel pattern;
the red sub-pixel pattern being formed of a red quantum dot material, the green sub-pixel pattern being formed of a green quantum dot material, the blue sub-pixel pattern being formed of a blue quantum dot material or a non-luminous transparent organic material;
wherein when blue-violet light or blue light irradiates the color light-emitting element from a side thereof associated with the reflection enhancement film, the red sub-pixel pattern, the green sub-pixel pattern, and the blue sub-pixel pattern of the photo-luminescent film respectively emit red, green, and blue light and the light emitting from the photo-luminescent film is condensed through the reflection enhancement film and the transmission enhancement film and then transmitted out from a side associated with the transmission enhancement film.

6. The liquid crystal display as claimed in claim 5, wherein for the blue sub-pixel pattern being formed of the blue quantum dot material, the backlight module supplies blue-violet light; and for the blue sub-pixel pattern being formed of the non-luminous transparent organic material, the backlight module supplies blue light.

7. The liquid crystal display as claimed in claim 5, wherein the lower substrate comprises a second base plate, a lower polarizer formed on a lower surface of second base plate, a thin-film transistor (TFT) layer formed on the second base plate, and a pixel electrode formed on the TFT layer, and a second alignment film formed on the pixel electrode.

8. The liquid crystal display as claimed in claim 5, wherein the reflection enhancement film has a thickness of 320 nm-350 nm, 1900 nm-2200 nm, or 2150 -2300 nm; and the transmission enhancement film has a thickness of 110 nm-160 nm, 1430 nm-1490 nm, or 1720 nm-1760 nm.

9. A liquid crystal display, comprising a liquid crystal display panel and a backlight module arranged at one side of the liquid crystal display panel;
the liquid crystal display panel comprising an upper substrate, a lower substrate opposite to the upper substrate, a liquid crystal layer arranged between the upper substrate and the lower substrate, and photo spacers formed between the upper and lower substrates;
the upper substrate comprising a first base plate, a color light-emitting element formed under the first base plate, an upper polarizer formed under the color light-emitting element, and a common electrode and a first alignment film formed under the upper polarizer; the color light-emitting element comprising a photo-luminescent film and a reflection enhancement film and a transmission enhancement film respectively formed on two opposite sides of the photo-luminescent film;
the photo-luminescent film comprising a red sub-pixel pattern, a green sub-pixel pattern, and a blue sub-pixel pattern;
the red sub-pixel pattern being formed of a red quantum dot material, the green sub-pixel pattern being formed of a green quantum dot material, the blue sub-pixel pattern being formed of a blue quantum dot material or a non-luminous transparent organic material;
wherein when blue-violet light or blue light irradiates the color light-emitting element from a side thereof associated with the reflection enhancement film, the red sub-pixel pattern, the green sub-pixel pattern, and the blue sub-pixel pattern of the photo-luminescent film respectively emit red, green, and blue light and the light emitting from the photo-luminescent film is condensed through the reflection enhancement film and the transmission enhancement film and then transmitted out from the side of the transmission enhancement film.

10. The liquid crystal display as claimed in claim 9, wherein for the blue sub-pixel pattern being formed of the blue quantum dot material, the backlight module supplies blue-violet light; and for the blue sub-pixel pattern being formed of the non-luminous transparent organic material, the backlight module supplies blue light.

11. The liquid crystal display as claimed in claim 9, wherein the lower substrate comprises a second base plate, a lower polarizer formed on a lower surface of second base plate, a thin-film transistor (TFT) layer formed on the second base plate, and a pixel electrode formed on the TFT layer, and a second alignment film formed on the pixel electrode.

12. The liquid crystal display as claimed in claim 9, wherein the reflection enhancement film has a thickness of 320 nm-350 nm, 1900 nm-2200 nm, or 2150-2300 nm; and the transmission enhancement film has a thickness of 110 nm-160 nm, 1430 nm-1490 nm, or 1720 nm-1760 nm.
